(19) United States
(12) Patent Application Publication
(10) Pub. No.: US 2008/0086226 A1
(43) Pub. Date: Apr. 10, 2008

(54) INTERNET ENABLED VOICE COMMUNICATION

(76) Inventors: Gene Fein, Lenox, MA (US); Edward Merritt, Lenox, MA (US)

Correspondence Address: BERKELEY LAW & TECHNOLOGY GROUP, LLP, 17933 NW Evergreen Parkway, Suite 250, BEAVERTON, OR, 97006, US

(21) Appl. No.: 11/548,188

(22) Filed: Oct. 10, 2006

(51) Int. Cl. G06F 17/00

(52) U.S. Cl. 700/94

(57) ABSTRACT

The subject matter disclosed herein relates to a method and/or system for enabling voice communication over an Internet Protocol.

### BACKGROUND

1. Field

The subject matter disclosed herein relates communication over a packet-enabled network.

2. Information

The voice over the Internet protocol (VoIP) provides a low cost method of telephonic communication over public communication networks. Mobile devices with connections to the Internet, for example, may participate in telephonic conversations through a network operations center and/or Internet Service Provider (ISP).

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of a network topology enabling voice communication between a calling party at a calling party device and a called party at a called party device according to an embodiment.

FIG. 2 is a flow diagram depicting a process executed by a device in connection with initiating a call with a called party according to an embodiment.

FIG. 3 is a flow diagram depicting a process executed by an intermediary node to establish secure connections with a calling parting and a called party according to an embodiment.

FIG. 4 is a schematic diagram of a network topology enabling voice communication between a calling party and a called party comprising a cellular telephone according to an embodiment.

FIG. 5 is a schematic diagram of a network topology illustrating alternative intermediary nodes for routing voice packets between called and calling parties.

FIG. 6 is a schematic diagram illustrating distribution of software to a device enabling the device to operate interchangeably as a calling party device, called party device or an intermediate node according to an embodiment.

FIG. 7 is a schematic diagram illustrating use of a calling party device capable of bypassing a network operations center to access an intermediary node according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

Unless specifically stated otherwise, as apparent from the following discussion, it is appreciated that throughout this specification discussions utilizing terms such as “processing,” “computing,” “storing,” “selecting,” “forming,” “enabling,” “inhibiting,” “rendering,” “presenting,” “accessing,” “identifying,” “initiating,” “encrypting,” “obtaining,” “hosting,” “decrypting,” “representing,” “modifying,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices. Such actions and/or processes may be executed by a computing platform under the control of machine-readable instructions stored in a storage medium. Further, unless specifically stated otherwise, process described herein, with reference to flow diagrams or otherwise, may also be executed and/or controlled, in whole or in part, by such a computing platform.

A “computer program” has referred to herein relates to an organized list of instructions that, when executed, causes a computing platform and/or machine to behave in a predetermined manner. Here, for example, a computer program may comprise machine-readable instructions that are executable by a computing platform to perform one or more desired tasks. In one particular embodiment, although claimed subject matter is not limited in these respects, a computer program may define inputs and outputs such that execution of the program may provide outputs based, at least in part, on the inputs. However, these are merely examples of a computer program and claimed subject matter is not limited in these respects.

According to an embodiment, a computer program may comprise one or more “software components” comprising instructions that are executable as an integrated part of the computer program. Here, for example, computer program may comprise multiple software components that are individually created to perform associated functions of the computer program. The different components may then be integrated together to provide a functioning computer program. However, these are merely examples of a computer program and claimed subject matter is not limited in these respects.

VoIP networks typically required specialized network elements such as dedicated network operations centers (NOCs) to facilitate routing traffic between calling and called parties. According to an embodiment, any one of several nodes connected to the Internet may transmit voice data between calling and called parties to eliminate the necessity of NOCs for such a function. Also, and as illustrated below, such intermediate nodes may enable VoIP calls between parties when at least one of a calling party device or a called party device is outside of a VoIP network. It should be understood, however, that these are merely illustrative examples and that claimed subject matter is not limited in this respect.

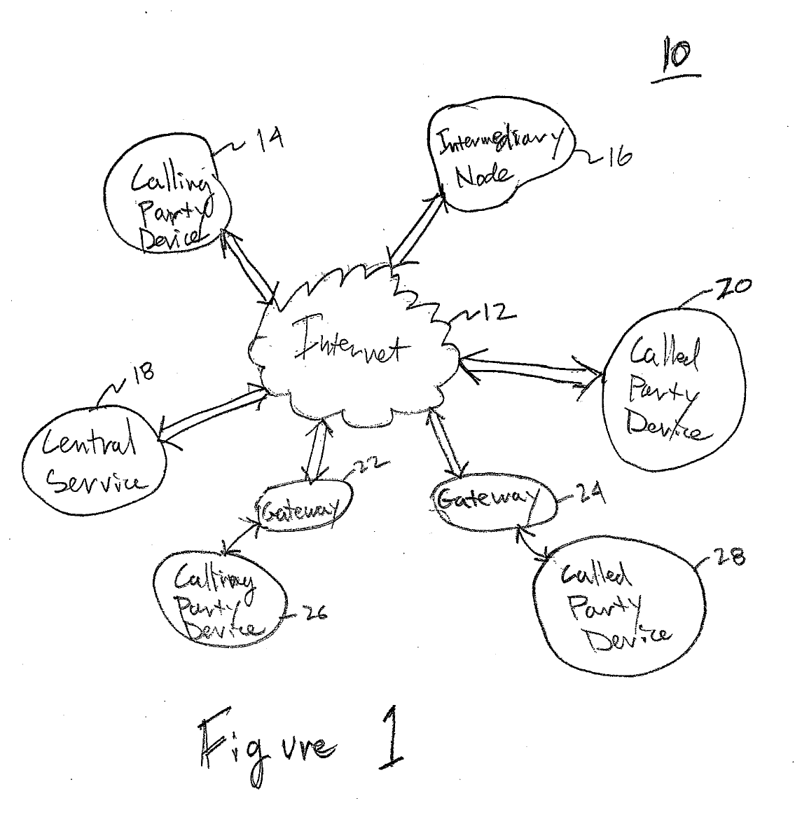

FIG. 1 is a schematic diagram of a network topology 10 enabling voice communication between a calling party at a calling party device 14 or 26 and a called party at a called party device 20 or 28 through Internet 12. In a particular embodiment, Internet 12 may comprise infrastructure and/or devices such as network routers to forward packets between devices according to an Internet Protocol (IP). As such, calling party device 14 and called party device 20 may comprise circuitry, logic and/or computing resources to process and format information into data packets for transmission to devices connected to Internet 12. Similarly, calling party device 14 and called party device 20 may be capable of extracting information from received data packets in the course of conducting a telephonic conversation. Calling party device 14 and called party device 20 may also comprise other components to enable telephonic voice communication such as, for example, a voice codec, speaker and microphone. However, these are merely examples of a called party and calling party devices, and claimed subject matter is not limited in this respect.

In an alternative embodiment, a called party device and calling party device need not be connected directly to Internet 12, but may be connected to Internet 12 through a gateway. For example, calling party device 26 may be connected to gateway 22 through a network dedicated to telephonic communication such as a public switched telephone network (PSTN) or any one of several mobile wireless voice carrier networks. Likewise, called party device 28 may similarly be connected to gateway 24 through a network dedicated to telephonic communication. In one particular embodiment, gateway 22 may facilitate access number dialing in which an identifier provided by calling party device 26 (e.g., an e.164 code) may be translated to an extension associated with called party 20 on a VoIP network. Accordingly, gateway 22 may initiate a call with called party 20 using the translated extension on the VoIP network. Similarly, gateway 24 may translate an extension on a VoIP network associated with called party device 28 to an identifier that may be used for completion of a call with called party device 28 through a network dedicated to telephonic communication.

According to an embodiment, data packets for a call may be transmitted between a called party device and a calling party device through intermediary node 16. As illustrated below according to particular embodiments, intermediary node 16 may a first IP connection (e.g., a TCP/IP connection) may be established for transmitting information between an intermediary node 16 and a calling party device, and a second IP connection may be established for transmitting information between intermediary node 16 and a called party device. For example, such a first IP connection may be established between intermediary node 16 and either calling party device 14 or gateway 22. Similarly, such a second IP connection may be established between intermediary node 16 and either called party device 20 or gateway 24. Accordingly, intermediary node 16 may comprise IP routing capability to route data packets between the first and second IP connections.

In an alternative embodiment, also as illustrated below, such first and second IP connections may be encrypted. For example, payloads of voice data transmitted in the first IP connection may be encrypted according to an encryption key accessible by an intermediate node and a calling party device or gateway connected to a calling party device. Similarly, payloads of voice data transmitted in the second IP connection may be encrypted according to an encryption key accessible by an intermediate node and a called party device or gateway connected to a called party device. In one embodiment, encryption keys for encrypting voice data may be provided by central service 18. For example, central service 18 may provide encryption keys to a called party device, calling party device, intermediate node and/or gateway when a call is initiated. In one alternative, central service 18 may periodically change encryption keys for enhancing security of voice data transmitted between calling and called party devices.

According to an embodiment, and as illustrated below with particular examples, a central service 18 may select intermediate node 16 from among a plurality of candidate nodes (not shown) connected to Internet 12 for forwarding data packets between calling and called party devices in a telephone call. In addition, central service 18 may facilitate billing and collection functions in connection with the service. In one particular embodiment, although claimed subject matter is not limited in this respect, central service 18 may comprise a Web service to integrate applications hosted among intermediary node 16, devices 14 and 20, and/or gateways 22 and 24. Here, such a Web service may integrate applications using an Internet protocol (IP) infrastructure. In particular examples of a Web service, although claimed subject matter is not limited in these respects, standard protocols may be employed to transmit data objects among components over an Internet protocol such as, for example, HTTP, HTTPS, XML, SOAP, WSDL and/or UDDI standards. Here, XML may be used to tag data objects, SOAP may be used to transfer data objects, WSDL may be used to describe available services and UDDI may be used to list available services. However, these are merely examples of protocols that may enable a Web service and claimed subject matter is not limited in these respects.

According to an embodiment, central service 18 may register participant devices to act as either a calling party device, called party device or an intermediate node. In particular embodiments, as illustrated below, such a participant device may act interchangeably as a calling party device, called party device or an intermediate node. A party may register its device to participate by contacting central service 18 by, for example, interacting with a website operated by or on behalf of central service 18. Here, for example, a party may contact such a website through selection of a universal resource locater (URL) using a web browser, installed on the device to be registered for example. Through the website, a participant may provide registration and/or billing information. Also as part of such a registration process, a participant may download software from the website to be installed on a participant device to enable the participant device to act as a calling party device, called party device and/or intermediate node as illustrated below.

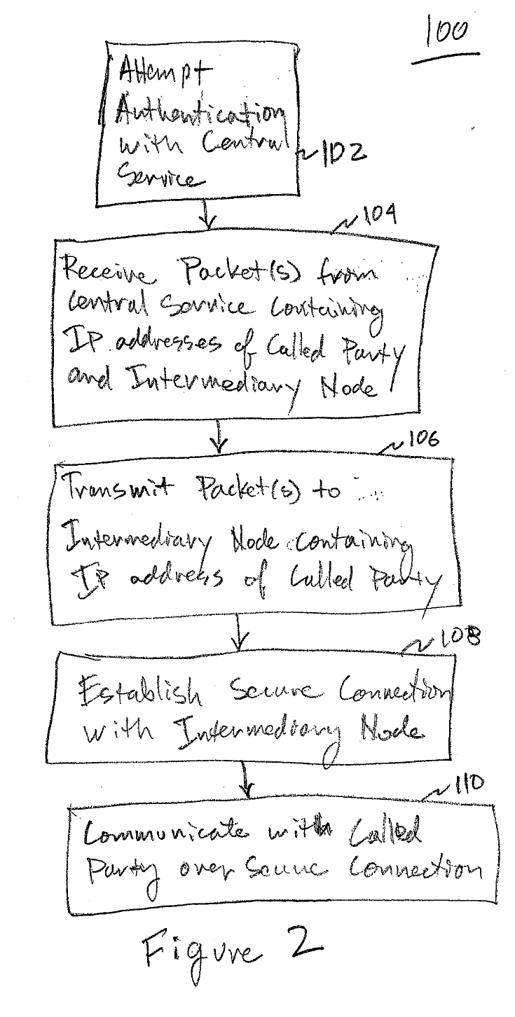

FIG. 2 is a flow diagram depicting a process 100 executed by a device in connection with initiating a call with a called party according to an embodiment. In one embodiment, process 100 which may be executed by a calling party device connected directly to an Internet such as calling party device 14. Alternatively, process 100 may be executed by a gateway device, such as gateway 22, in response to an attempt for access number dialing from a calling party device not connected directly to the Internet, such as calling party device 26. However, these are merely examples of devices that may be employed for initiating a call with a called party according to particular embodiments and claimed subject matter is not limited in these respects.

Block 102 comprises an attempt to authenticate a calling party, with a central service, for example. This may comprise, for example, providing a username and password to a user interface. Such information may be transmitted to the central service in data packets using any one of several protocols enabled by IP infrastructure such as HTML and/or as part of a web service as illustrated above. Such information may also include information identifying an intended called party such as, for example, an extension on a VoIP network or e.164 code associated with the intended called party.

Following a successful authentication of the calling party, block 104 may receive one or more data packets from a central service containing an IP address of the intended called party and an IP address of an intermediary node selected by the central service for forwarding data packets. To initiate a call with the intended called party, Block 106 may transmit one or more data packets to the selected intermediary node addressed according to information received at block 104. Here, block 106 may address these data packets with an IP address of the selected intermediary node received in data packets at block 104. Additionally, data packets transmitted at block 106 may specify an IP address of the intended called party received at block 104. Following a response from the selected intermediary node, block 108 may establish a secure connection with the intermediary node including, for example, establishing one or more TCP/IP connections to carry voice data between the intermediary node and a device (e.g., gateway or calling party device) in addition to any encryption of voice data transmitted therein. Block 110 may then commence communicating with a called party over the secure connection established at block 108.

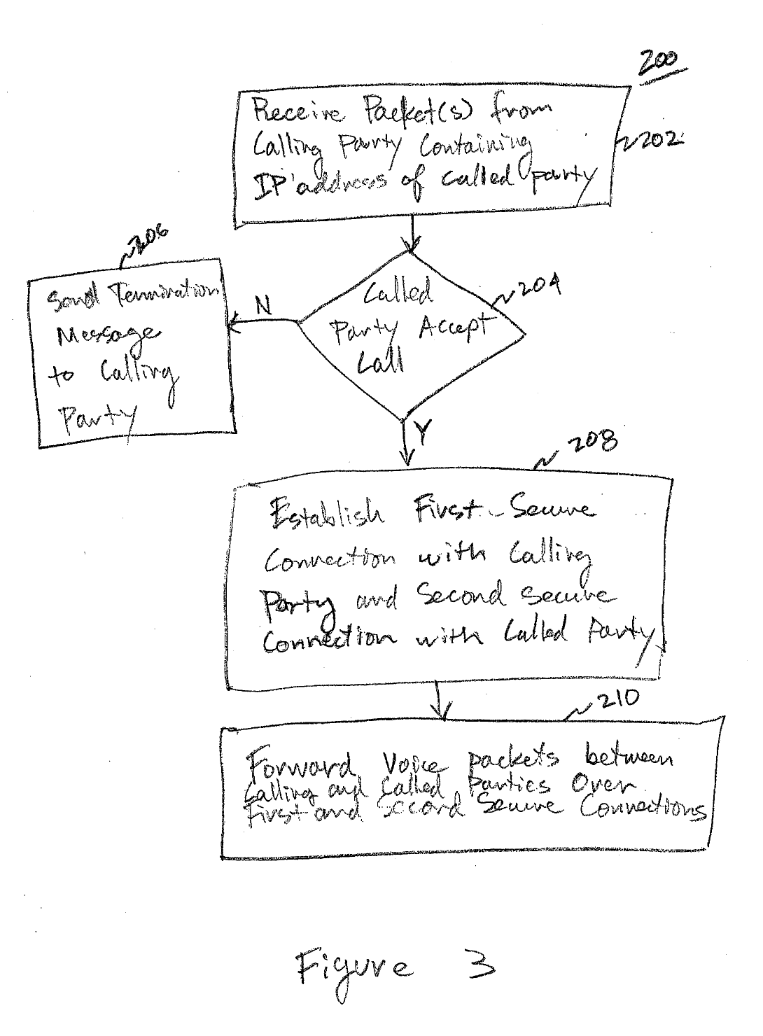

FIG. 3 is a flow diagram depicting a process 200 executed by an intermediary node to establish secure connections with a calling party and a called party according to an embodiment. At block 202, the intermediary node may receive one or more data packets from a device (e.g., gateway or calling party device) requesting an initiation of a telephone call with an intended called party. Such packets may comprise, for example, an IP address associated with the intended called party (e.g., associated with a called party device and/or gateway). Diamond 204 may determine whether the intended called party is able to accept the call by, for example, transmitting one or more “ring” packets according to the aforementioned VoIP protocol. Upon receipt of a “busy” message or in the absence of an “off-hook” message in response to the “ring” packets, block 206 may transmit a termination message indicating that the intended called party cannot be reached in one or more packets addressed according to an IP address associated with the calling party address (e.g., an IP address associated with a gateway and/or calling party device).

Upon receiving an acceptance of the call by, for example, receiving a packet with an “off-hook” message, block 208 may establish a first secure connection with a calling party to transmit voice data between the calling party and the intermediary node, and a second secure connection to transmit voice data between the accepting called party and the intermediary node. As illustrated above, such first and second secure connections may comprise TCP/IP connections capable of transmitting encrypted voice data. Once first and second secure connections are established, block 210 may forward and/or route data packets carrying voice data between calling and called parties over the first second secure connections.

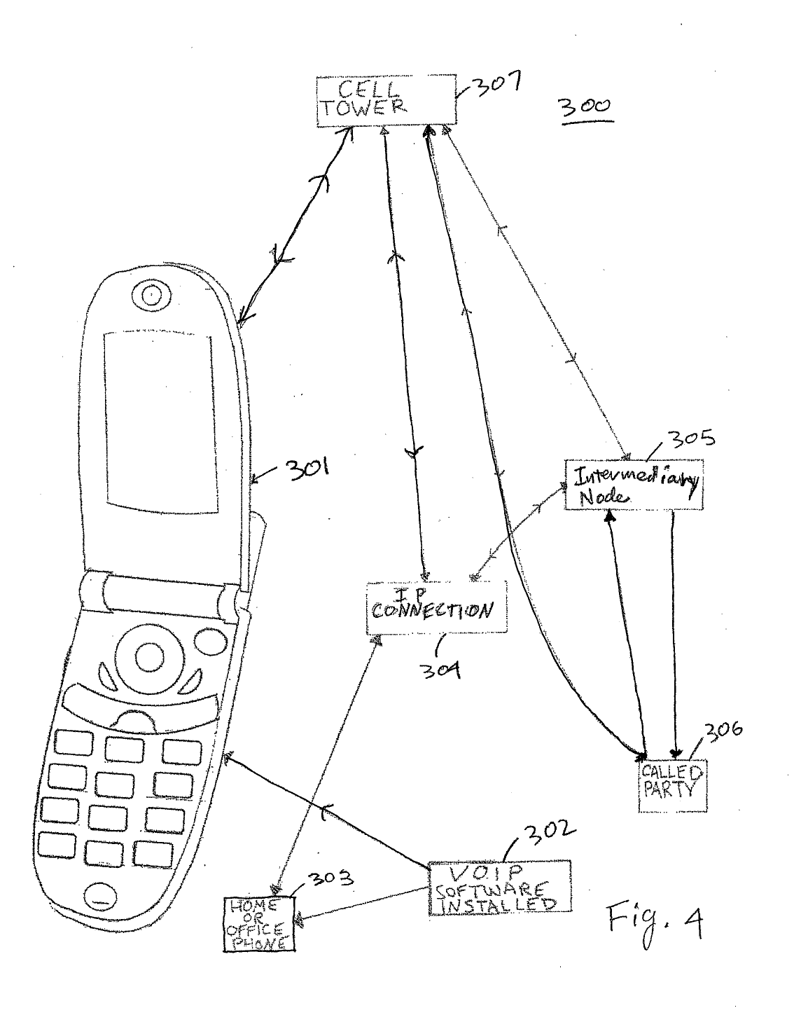

FIG. 4 is a schematic diagram of a network topology 300 enabling voice communication between a calling party and a called party comprising a cellular telephone according to a particular embodiment. Here, a calling party device may comprise any one of several devices and/or computing platforms such as, for example, a mobile handset 301, home or office phone 303 or a personal computer (not shown). In the presently illustrated embodiments, a calling party device may comprise a computing platform capable of hosting software 302 enabling functionality of a calling party device. Such software 302 may comprise machine-readable instructions enabling a device to perform process 100 shown in FIG. 2 and processing data packets carrying voice data according to well known VoIP protocols, for example. In one embodiment, such software may be pre-installed to the device by a manufacturer or service provider distributing the device. Alternatively, a user may install such software from an insertable memory device (e.g., CD ROM or flash card) or by downloading the software from a website. In another embodiment as illustrated above, such software may be downloaded from a central service such as central service 18 shown in FIG. 1. It should be understood, however, that these are merely examples of how a user may install software to a computing platform to enable a calling party device to communicate with a called party device and claimed subject matter is not limited in this respect.

In the presently illustrated embodiment, a calling party device may communicate with intermediary node 305 through an IP connection 304 established as illustrated above according to particular embodiments. A calling party device may then communicate with a called party device 306 through intermediate node 306 according to particular embodiments as illustrated above, for example. In one embodiment, calling party device 303 may establish IP connection 304 through a connection to a broadband Internet service provider (ISP) through a digital subscriber line (DSL), a coaxial cable, a fiber optic cable, or a wireless broadband link provided according to one or more versions of IEEE 802.16, for example. Alternatively, handset 310 (acting as a calling party device) may be connected through a cellular communication service provider having a cell tower 307. Here, for example, such a service provider may establish IP connection 304 through a gateway (not shown) as illustrated above, for example. However, this is merely an example of how a mobile handset may be connected to an IP connection through a cellular communication service provider according to a particular embodiment and claimed subject matter is not limited in this respect.

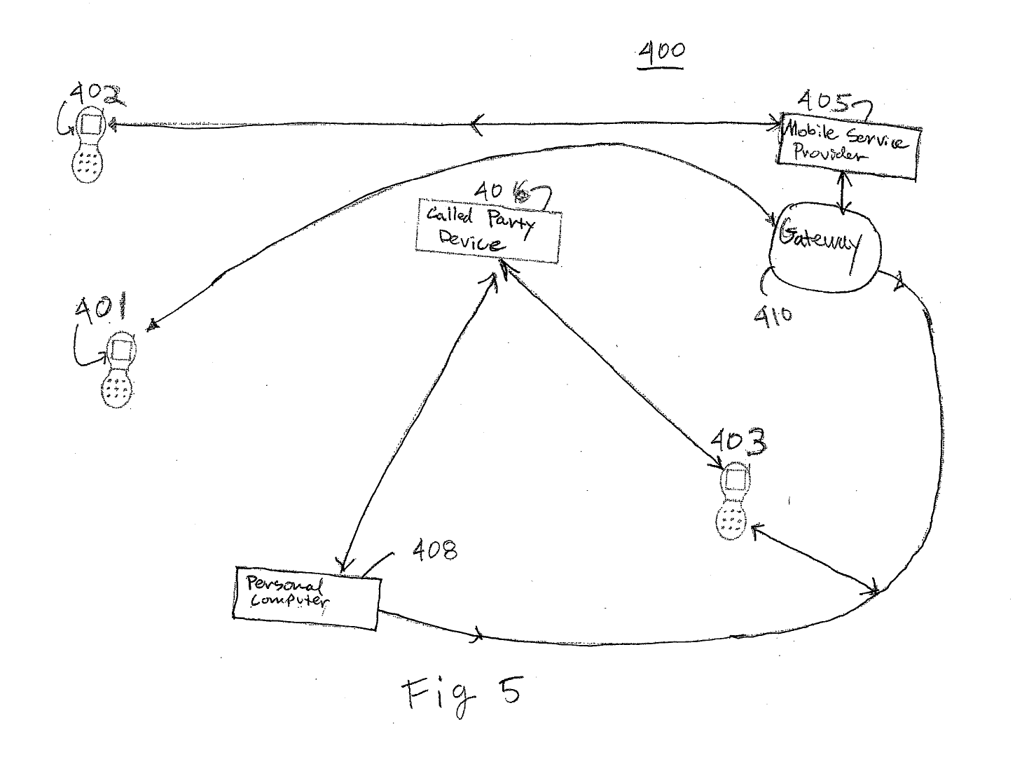

FIG. 5 is a schematic diagram of a network topology 400 illustrating alternative intermediary nodes for routing voice packets between called and calling parties. According to an embodiment any particular device connected to the Internet may serve interchangeably as a calling party device, called party device or an intermediate node. Here, for example, mobile handset 402 connected to mobile service provider 405 may act as a calling party device or a called party device for communicating with other devices in a VoIP network through gateway 410.

According to an embodiment, any one of several candidate devices may be selected to provide an intermediate node for transmitting voice data between a calling party device and a called party device. Here, a central service (not shown) may select such a device to act as such an intermediary node based, at least in part, upon predetermined criteria in response to a request from a calling party to initiate a call. Such predetermined criteria may include, for example, reliability of candidate devices and/or least cost routing criteria, just to name a few criteria. In a particular example, either personal computer 408 or mobile handset 403 may act as an intermediate node for transmitting voice data between mobile handset 402 (acting as a calling party device through mobile service provider 405 and gateway 410) and called party device 406 over established IP connections as illustrated above. Here, for example, mobile handset 403 acting as an intermediary node may establish a first encrypted IP connection with gateway 410 and a second encrypted IP connection with called party device 406. In an alternative embodiment, although claimed subject matter is not limited in this respect, gateway 410 may act as an intermediary node to facilitate communication between mobile handset 401 (acting as a calling party device) and mobile handset 403 (acting as a called party device). Here, gateway 410 may establish a first IP connection with mobile handset 401 and a second IP connection with mobile handset 403 as illustrated above.

For simplicity, embodiments described above identify a single intermediary node for forwarding voice data between calling and called party devices over IP connections. It should be understood that other embodiments may employ two or more intermediary nodes for forwarding voice data between calling and called party devices. In a particular example, a first IP connection may transmit voice data between a first intermediary node and a calling party device, and a second IP connection may transmit voice data between a called party device and a second intermediate node. One or more additional IP connections may then transmit voice data between the first and second intermediate nodes. According to an embodiment, such multiple intermediary nodes may be determined by a central service (e.g., central service 18) in response to a calling party's request for placing a call with an intended called party.

In some embodiments, a single intermediate node may not have sufficient forwarding capacity to forward all voice data desired to be transmitted between a calling party and called party devices. In a particular embodiment, multiple IP connection may transmit data between a calling and/or called party device and an associated multiple intermediary nodes. Here, data packets carrying voice data may transmitted over parallel IP connections for reassembly at a destination in an ordered sequence. Again, such multiple intermediary nodes may be determined by a central service (e.g., central service 18) in response to a calling party's request for placing a call with an intended called party.

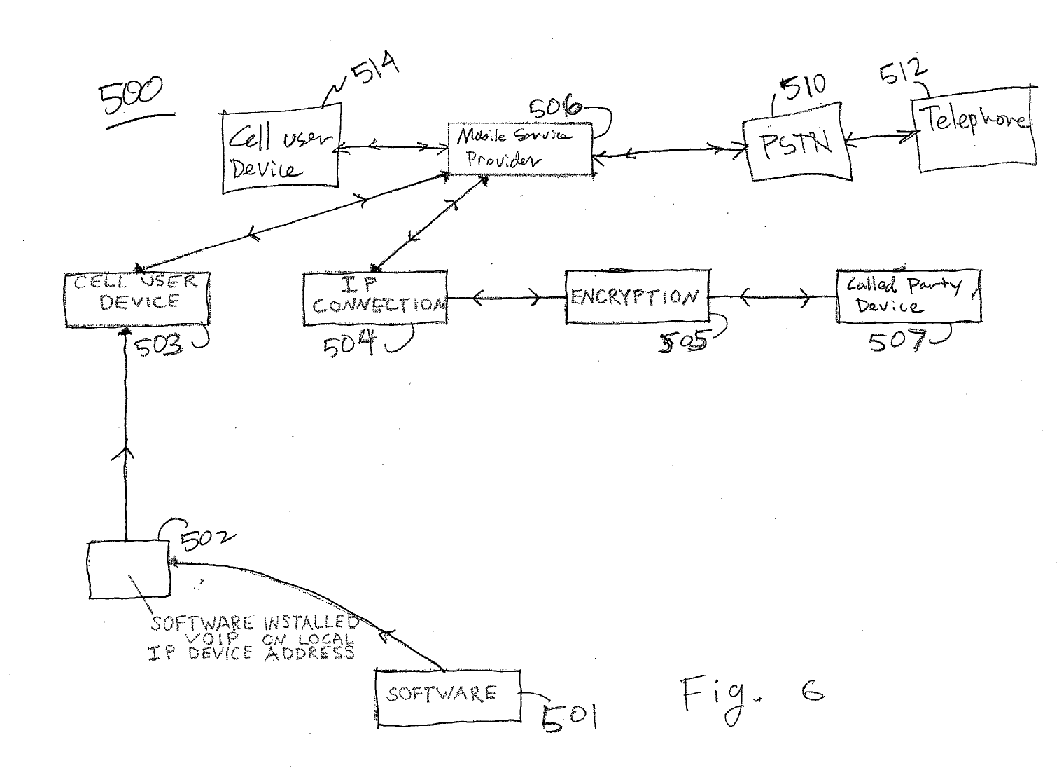

FIG. 6 is a schematic diagram illustrating distribution of software to a device enabling the device to operate interchangeably as a calling party device, called party device multiple alternative paths for a call between a calling party device and a called party device according to an embodiment. Software 501 may be installed on a computing platform 502 (such as a personal computer) enabling a device to operate interchangeably as a calling party device, called party device or intermediary node, in a particular embodiment. Here, computing platform 502 may obtain an IP address that is either statically allocated or obtained from a Dynamic Host Configuration Protocol (DHCP) service such as that of an ISP. According to an embodiment, software 501 installed on computing platform 502 may be ported to a cellular device 503 (e.g., mobile handset) using any one of several communication links such as, for example, Universal Serial Bus (USB) connection, Firewire connection, Bluetooth connection, Ethernet connection and/or the like. Cellular device 503 may then obtain its own IP address for use in conjunction with ported software to place calls with and/or receive calls from another device through an intermediary node as illustrated above.

In the presently illustrated embodiment, cellular user device 503 may communicate with mobile service provider 506 through, for example, a cell tower (not shown). In addition, such a cellular user device 503 may still be used to initiate calls with a cellular user device 514 also served by mobile service provider 506, as well as initiate calls with telephone 512 through PSTN 510. However, with software 501 installed on cellular user device 503, according to an embodiment, cellular user device 503 may act as a calling party device to initiate a call with called party device 507 through an intermediary node (not shown). Here, for example, mobile service provider 506 may comprise, or be connected to, a gateway (not shown) capable of communicating with called party device 507 through IP connection 504. In addition, as illustrated above, encryption 505 may be added to IP connection 504, optionally at an intermediary node (not shown). IP connection 504, as illustrated in FIG. 6, represents an exemplary IP to transmit voice data in a path between cell user device 503 and called party device 507 may comprise. For example, IP connection 504 may represent a first IP connection transmitting voice data between cell user device 503 and an intermediate node, a second IP connection transmitting voice data between an intermediate node and called party device 507, or a combination of such first and second IP connections.

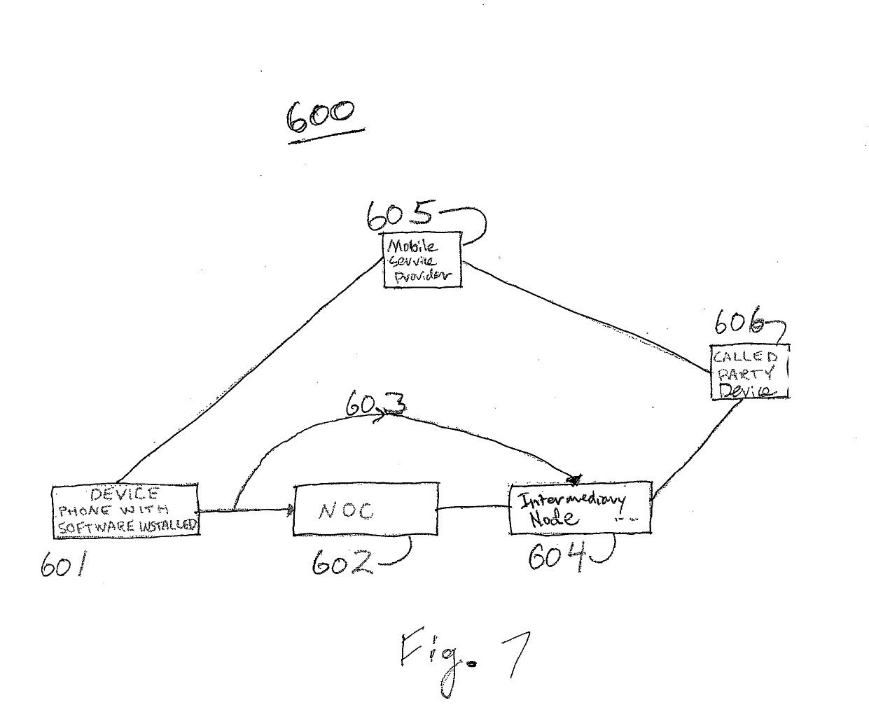

FIG. 7 is a schematic diagram of a network topology 600 illustrating use of a calling party device 601 capable of bypassing a network operations center 602 to access an intermediary node 604. Here, calling party device 601 may be connected to mobile service provider 605 through a cell tower (not shown) for example. Accordingly, calling party device 601 may initiate a call with called party device 606 through either mobile service provider 605 or intermediary node 604 using techniques illustrated above as examples. To initiate a call with called party device 606, calling party device 601 may establish an IP connection with intermediary node 604 through a network operations center (NOC) 602 such as an ISP. Here, for example, device 601 may comprise a wireless transceiver capable of communicating with a wireless access point over an IEEE Std. 802.11 wireless link, for example.

In an alternative embodiment, although claimed subject matter is not limited in this respect, device 601 may bypass NOC 602 to communicate with intermediary node 604 and place a call to called party device 606. For example, device 601 may be equipped with a short-range wireless transceiver (e.g., Bluetooth, IEEE Std. 802.11, radio frequency ID transceiver, “Wibree” technology promoted by Nokia and/or the like) capable of transmitting and receiving voice packets on a wireless transmission link between device 601 and intermediary node 604. However, this is merely an example of how a calling party device may bypass an NOC to connect directly to an intermediary node according to a particular embodiment and claimed subject matter is not limited in this respect.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. A method comprising:
receiving one or more data packets from a calling party, said one or more data packets comprising an IP address associated with an intended called party;
establishing a first IP connection between an intermediary node and said calling party;
establishing a second IP connection between said intermediary node and said intended called party; and
forwarding packets between said intended called party and said calling party through said first and second IP connections to facilitate voice communication between said called and calling parties.

2. The method of claim 1, wherein said establishing said first IP connection further comprises establishing an encrypted connection between said calling party and said intermediary node according to a first encryption key accessible at a calling party device.

3. The method of 2, wherein said establishing said second IP connection further comprises establishing an encrypted connection between said called party and said intermediary node according to a second encryption key accessible at a called party device.

4. The method of claim 1, wherein said IP address associated with an intended called party comprises a static IP address associated with a called party device.

5. The method of claim 1, and further comprising authenticating said calling party based, at least in part, on said one or more IP packets received from said calling party.

6. The method of claim 5, wherein said authenticating further comprises communicating with a Web service.

7. A method comprising:
transmitting one or more packets to a central service comprising information associated with an intended called party;
receiving one or more packets from a central service comprising a first IP address associated with said intended called party and a second IP address associated with an intermediate node capable of establishing a first connection to a calling party and a second connection to a called party; and
transmitting one or more packets addressed according to said second IP address to initiate voice communication between said calling party and said called party.

8. The method of claim 7, and further comprising communicating with said central service to authenticate said calling party.

9. The method of claim 7, and further comprising initiating said transmitting one or more packets to said central service in response to a message received at a gateway from a calling party device.

10. The method of claim 7, wherein said information associated with said intended called party comprises an extension on a VoIP network.

11. The method of claim 7, wherein said information associated with said intended called party comprises an e.164 code.

12. An article comprising:
a storage medium comprising machine-readable instructions stored thereon which, when executed, are adapted to cause a computing platform to:
receive one or more data packets from a calling party, said one or more data packets comprising an IP address associated with an intended called party;
establish a first IP connection between an intermediary node and said calling party;
establish a second IP connection between said intermediary node and said intended called party; and
forward packets between said intended called party and said calling party through said first and second IP connections to facilitate voice communication between said called and calling parties.

13. An article comprising:
a storage medium comprising machine-readable instructions stored thereon which, when executed, are adapted to cause a computing platform to:
transmit one or more packets to a central service comprising information associated with an intended called party;
receive one or more packets from a central service comprising a first IP address associated with said intended called party and a second IP address associated with an intermediate node capable of establishing a first connection to a calling party and a second connection to a called party; and
transmit one or more packets addressed according to said second IP address to initiate voice communication between said calling party and said called party.

14. A network node, said network node being adapted to:
establish a first connection with a calling party according to an Internet protocol in response to a call initiated by said calling party;
establish a second connection with a called party according to said Internet protocol in response to said call; and
transmit data packets between said calling party and said called party over said first and second connections.

15. The network node of claim 14, wherein said first connection comprises a first TCP/IP connection between said network node and said calling party, and wherein said second connection comprises a second TCP/IP connection between said network node and said called party.

16. A method comprising:
authenticating a calling party for placing a call to a called party device;
identifying one or more intermediary nodes for transmitting voice data between a calling party device associated with said calling party and a called party device; and
transmitting one or more data packets addressed to said calling party device comprising an IP address associated with at least one of said one or more intermediary nodes in response to said authenticating said calling party.

17. The method of claim 16, wherein said identifying said one or more intermediary nodes further comprises:
identifying a first intermediary node for communicating with said calling party device over a first IP connection; and
identifying a second intermediary node for communicating with said called party device over a second IP connection.

18. The method of claim 17, wherein said first intermediary node and said second intermediary node are adapted to transmit voice data between one another over a third IP connection.

19. The method of claim 16, wherein said identifying said one or more intermediary nodes further comprises:
identifying a plurality of intermediary nodes capable of forwarding voice data between said calling and calling party devices over parallel IP connections.
